(19) United States
(12) Patent Application Publication
(10) Pub. No.: US 2017/0242258 A1
(43) Pub. Date: Aug. 24, 2017

(54) Embedded Reflective Eyepiece

(71) Applicant: Kopin Corporation, Westborough, MA (US)

(72) Inventor: Timothy James Edwards, Scotts Valley, CA (US)

(21) Appl. No.: 15/422,302

(22) Filed: Feb. 1, 2017

Related U.S. Application Data
(60) Provisional application No. 62/289,408, filed on Feb. 1, 2016.

(51) Int. Cl. G02B 27/02; G02B 5/30; G02B 27/14; G02B 27/28; G02B 25/00; G02B 27/30

(52) U.S. Cl. CPC G02B 27/027; G02B 25/001; G02B 27/30; G02B 27/142; G02B 27/286; G02B 5/3083; G02B 5/3016

(57) ABSTRACT

An embedded reflective eyepiece includes an optical lens, a beam splitter and reflective coating at a convex surface of the optical lens and a circular polarizing reflector surface having a concave surface of the optical lens. A method for forming a magnified image includes emitting circularly polarized light from a display source, at least partially refracting the circularly polarized light across a convex surface of a beam splitter reflective coating across a lens, at least partially reflecting refracted circularly polarized light internally off a concave circularly polarized reflector surface of the lens, and at least partially reflecting a reflected circularly polarized light internally off of the beam splitter reflective coating at the convex surface.

### RELATED APPLICATION

This application claims the benefit of U.S. Provisional Application No. 62/289,408, filed on Feb. 1, 2016. The entire teachings of the above application are incorporated herein by reference.

### BACKGROUND

While several types of optical collimating apparatus exist, they are all limited in accuracy of collimation and, often, size and weight. Examples of known optical collimating apparatus include those taught in U.S. Pat. No. 3,679,290, which discloses an optical filtering system employing combinations of cholesteric liquid crystal films; U.S. Pat. No. 4,704,010, disclosing a device employing a single, planar convex lens, wherein a collimating mark is applied on the convex surface and a reflective coating is applied to the central portion of the planar surface; and U.S. Pat. No. 5,050,966, teaching a multicolor display system fabricated by using multiple cholesteric elements tuned to different wavelengths.

Two other patents include U.S. Pat. No. 5,715,023, directed to a plane parallel optical collimating device employing a cholesteric liquid crystal, Hoppe, Michael J. and European Patent EP 1,024,388 A3 (Compact collimating apparatus, Hoppe, Michael J).

Therefore a need exists for a reflective eyepiece that overcomes and minimizes the above-referenced problems.

### SUMMARY OF THE INVENTION

The invention generally is directed to a reflective collimating eyepiece and to a method for forming a magnified image.

In one embodiment, the reflective collimating eyepiece of the invention includes an optical lens having a concave surface and a convex surface opposite the concave surface. A beam splitter reflective coating is at the convex surface. A circular polarizing reflector surface is at the concave surface, whereby circularly polarized light from a circularly polarized light source is refracted at the beam splitter reflective coating and reflected at the circular polarized reflector surface, and then reflected at the beam splitter reflective coating to form a beam of opposite circularly polarized light that is transmitted across the circular polarizing reflector, the combination of the refraction and reflection at the respective convex and concave surfaces of the optical lens thereby collimating and magnifying the image of the display source.

In another embodiment, the reflective collimating eyepiece further includes a display source, such as a circularly polarized light source, opposite the beam splitter reflective coating, wherein the display source directs predominantly circularly polarized light to the beam splitter reflective coating.

In another embodiment, the eyepiece includes a first piece and a second piece, with a ¼ wave plate between the first piece and the second piece.

In yet another embodiment, the invention is a method for forming a magnified image that includes emitting circularly polarized light from a circularly polarized light source, at least partially refracting the circularly polarized light across a convex surface of a beam splitter reflective coating and across an optical lens, and mostly reflecting the refracted circularly polarized light internally off a concave circularly polarized reflector surface of the optical lens. At least a portion of the reflected circularly polarized light is reflected internally off of the beam splitter reflective coating at the convex surface, whereby a beam of opposite circular polarization of the circularly polarized light is formed, thereby causing the beam of opposite circularly polarized light to be transmitted across the circular polarizing reflective surface, the combination of the refraction and reflection of the respective convex and concave surfaces of the optical lens thereby collimating and magnifying the image of the circularly polarized light source.

Advantages of the embedded reflective eyepiece and method of its use include the use of a single monolithic lens element in some embodiments. Also, the cost of manufacture is lower than is typically possible in embedded reflective eyepieces. Lower cost contributors include: single element compared to multi element refractive eyepiece; less expensive, single molded or dual molded lens elements; and reflective film polarizing technology that is potentially much cheaper than CLC or wire grid.

Further, the form factor of the reflective eyepiece in the invention is small. “Smaller” in this case is mostly traceable to the shorter folded optical eyepiece form in comparison to a refractive eyepiece design. The invention is also more stable in that the monolith eyepiece element form keeps the pieces bonded in it from moving relative to each other. Manufacture of the reflective eyepiece of the invention is easier than is typical in the field because there is an assumption that it is potentially possible to mold the optic as a single element as opposed to using multiple glass elements that must have additional alignment during assembly. There is a low angle of incidence at the image plane in that the view/image primarily is perpendicular to the display. In addition, a circular polarization reflector ¼ wave plate can be buried into a split, or doublet, lens element configuration. Further, the ¼ wave plate can be introduced as a flat element bonded within the monolithic glass element. This is important because curved waveplates are not mature and when bonded like this there is much less reflection from the bonded interfaces.

One improvement of this invention is an embedded monolithic nature of two separate shell-like optical elements using monolith single thick shell-like optical elements. This approach has improved performance that allows for wider field of view, and improved visual resolution.

The general reflective eyepiece approach of this invention provides for a shorter optical path by folding the optics on themselves in comparison to a standard refractive eyepiece where the light transmits in only one direction and images only by surface refraction. In the reflective eyepiece imaging also occurs by reflection which induces less color aberration within the optics. The curved reflective polarizing element with the embedded/monolithic optical allows for improved overall eyepiece performance.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a schematic representation of one embodiment of a reflective collimating eyepiece of the invention.

FIG. 2 is a schematic representation of another embodiment of the reflective collimating eyepiece of the invention.

FIG. 3 is a schematic representation of another embodiment, wherein the eyepiece is is a doublet.

FIG. 4 is a schematic representation of another embodiment, wherein the eyepiece is a doublet.

The same number in different figures represents the same item.

### DETAILED DESCRIPTION OF THE INVENTION

The invention generally is directed to a reflective collimating eyepiece, and to a method of forming a magnified and collimated image. “Embedded” is a reference to the single monolith lens nature of the optical design with the reflective elements embedded or incorporated on the two external surfaces.

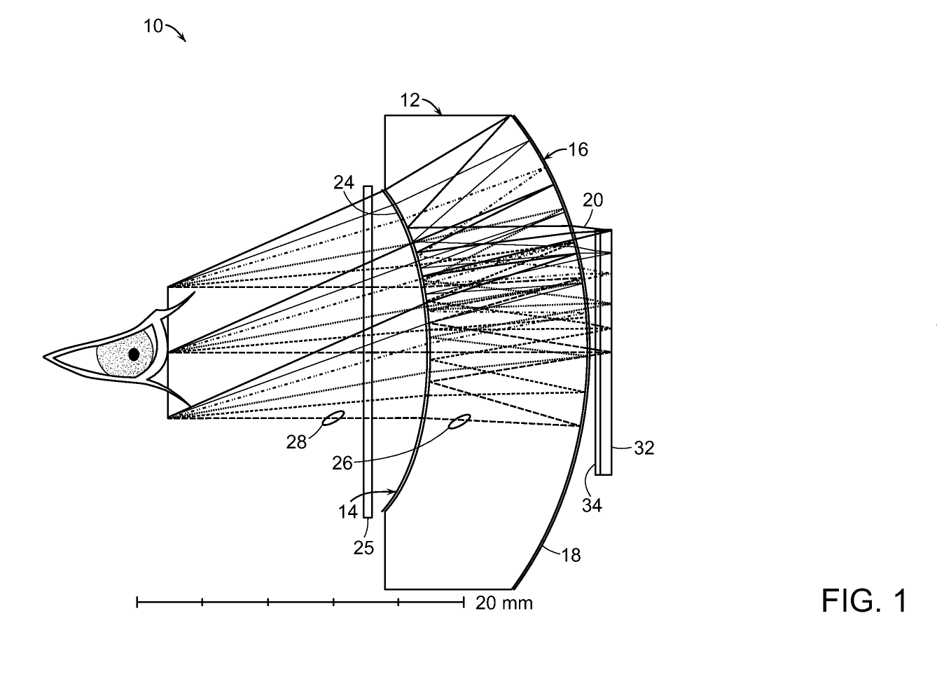

In one embodiment of the invention, shown in FIG. 1, reflective collimating eyepiece 10 includes optical lens 12. Optical lens 12 defines concave surface 14 and convex surface 16 opposite concave surface 14. Beam splitter reflective coating 18 is at convex surface 14. Generally, this is a dielectric coating with approximately 50:50 coating performance. 50:50 refers to the ratio between the reflected and transmitted light at the beamsplitter coating or the split ratio. Other ratios or reflective splits are also possible. The coating is designed to maintain polarization of transmitted and reflected polarized light. It could also be a partially reflective metal coating. Circular polarizing reflector 24 is at concave surface 14. Examples of materials suitable to form circular polarized reflector 24 include liquid crystal forms, a wire grid polarizer in combination with a ¼ wave plate, and a ¼ wave plate in combination with a linear polarizing reflector, such as are known in the art. In one embodiment, the liquid crystal form can be a cholesteric liquid crystal (CLC). CLC's are films that are monolithic circular polarizing films that reflect/transmit only one-handedness of polarized light. In another embodiment, a circular polarizing transmitter/reflector includes a linear polarizing reflector in combination with a ¼ waveplate element. In a specific embodiment, the linear polarizing reflector can be, for example, a wire grid polarizer. The ¼ waveplate is typically a film-based birefringent film, but could also be, for example, a crystalline waveplate. In this embodiment, the circular polarized light refracted transmitted/refracted at the beam splitter coating is first converted to linearly polarized light by the ¼ waveplate with a polarization orientation that will be reflected at the reflective polarizer film. After reflection at the reflective polarizer film the linearly polarized light is again converted to circular polarized light transmitting through the ¼ waveplate in the opposite direction. Circularly polarized light 20 from circularly polarized light source 22 is refracted at beam splitter reflective coating 18 and reflected at circular polarized reflector 24. Circularly polarized light 20 is then reflected at beam splitter reflective coating 18 to form beam 26 of oppositely circularly polarized light that is transmitted across circular polarized reflector surface 24. Linearly polarized light 28 is thereby formed when a linear polarizing filter and ¼ waveplate are employed, and circularly-polarized light is transmitted if a CLC layer is employed instead. If linearly polarized light is emitted from concave surface 14, then plate 25 can be an absorptive linear polarizer. On the other hand, if circularly polarized light is emitted from concave surface 14, then plate 25 can be a ¼ wave plate. The combination of refraction and reflection at convex surface 14 and concave surface 16, respectively, of optical lens 12 collimates and magnifies the image of circularly polarized light source 32.

In one embodiment, reflective eyepiece 10 includes circularly polarized light source 32 opposite beam splitter reflective coating 18, wherein circular polarized light source 22 directs predominantly circularly polarized light 20 to beam splitter reflective coating 18. In one embodiment, circular polarized light source includes non-polarized light source 32, and a polarizing filter 34 between non-polarized light source 32 and beam splitter reflective coating 18. In this embodiment, polarizing filter 34 can be, for example, a circular polarizer, or a ¼ wave plate combined with a polarizing film, that is located between beam splitter reflective coating 18 and non-polarized light source 32, wherein non-polarized light emitted by non-polarized light source 32 is polarized, so that beam splitter reflective coating 18 receives circularly polarized light from circularly polarized light source 32. Polarizing filter 34 can be any film that filters unpolarized light to generate a circular polarized output, such as a film that combines an absorptive polarizer film and ¼ wave birefringent film. Polarizing filter 34 first filters the light to make it linearly polarized and then converts the linearly polarized light to circular with a properly oriented ¼ wave film.

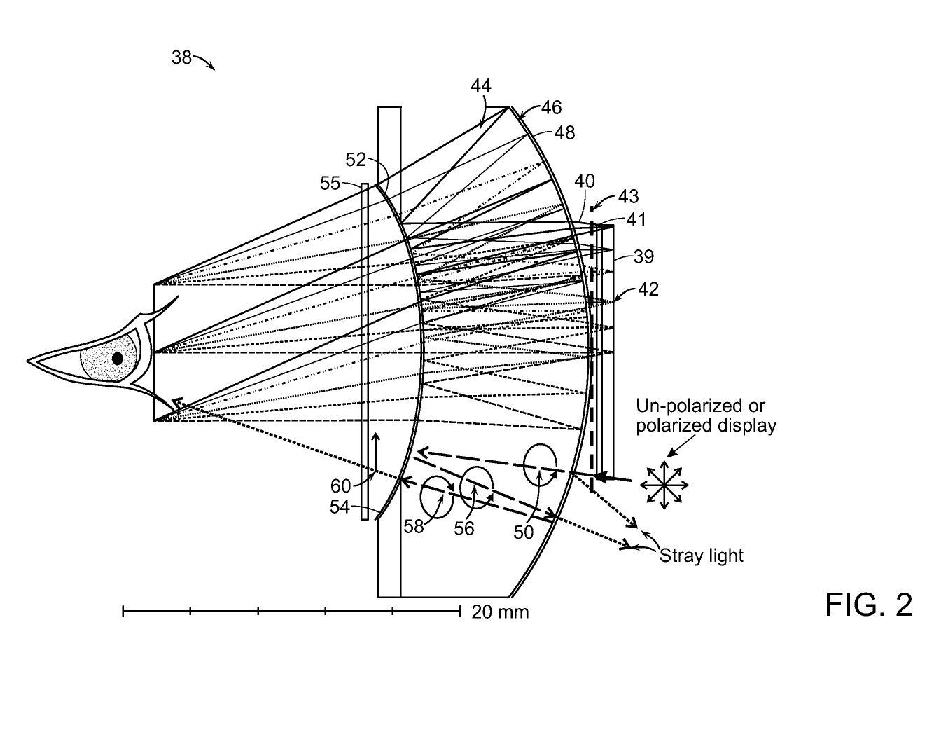

FIG. 2 is a schematic representation of one embodiment of a method of the invention. As shown in FIG. 2, the method includes emitting circularly polarized light 40 from circular polarized display source 42. Display source 42 typically includes unpolarized light source 39, linear polarizing filter 41, and ¼ wave plate) 43. A properly oriented combination of linear polarizer and ¼ wave film is one embodiment of a circular polarizer. Circularly polarized light 40 is at least partially refracted across convex surface 46 of optical lens 44 at beam splitter reflective coating 48 and across optical lens 44. At least a portion (e.g. most if not substantially all) of refracted circularly polarized light 50 is reflected internally off of concave circular polarized reflector surface 52 at concave surface 54 of optical lens 44. At least a portion of reflected circularly polarized light 56 is reflected internally off of beam splitter reflective coating 48 at convex surface 46, whereby beam 58 of opposite circular polarization of circularly polarized light is formed, thereby causing beam 58 of opposite circularly polarized light to be transmitted across circular polarizing reflector surface 52 to form linearly polarized light 60 if circular polarizing reflector 52 is a combination of a ¼ wave plate and a linear polarizing reflector. In which case, the light can then pass through absorptive linear polarizer 55. Alternatively, if circular polarizer 52 is a CLC, then the light emitted from concave surface 54 is circularly polarized, in which case plate 55 can be a ¼ wave plate and the light passes through the ¼ wave plate to become linearly polarized. The combination of the refraction and the reflection at convex 46 and concave 54 surfaces, respectively, of optical lens 44, thereby collimating and magnifying the image of display source 42.

In one specific embodiment, unpolarized light from non-polarized light source 39 is polarized by linear polarizing filter 41 and the polarized light is then circularly polarized by ¼ wave plate 43 and at least partially refracted at coating 48 of convex surface 46. Circularly polarized light 40 is at least partially refracted across convex surface 46 of optical lens 44 at beam splitter reflective coating 48 and across optical lens 44. At least a portion (or most if not substantially all) of refracted circularly polarized light 50 is reflected internally off of concave circular polarized reflector surface 52 at concave surface 54 of optical lens 44. At least a portion of reflected circularly polarized light 56 is reflected internally off of beam splitter reflective coating 48 at convex surface 46, whereby beam 58 of opposite circular polarization of circularly polarized light is formed, thereby causing beam 58 of opposite circularly polarized light to be transmitted across circular polarizing reflector 52. The combination of the refraction and the reflection at convex 46 and concave 54 surfaces, respectively, of optical lens 44, thereby collimate and magnify the image of display source 42.

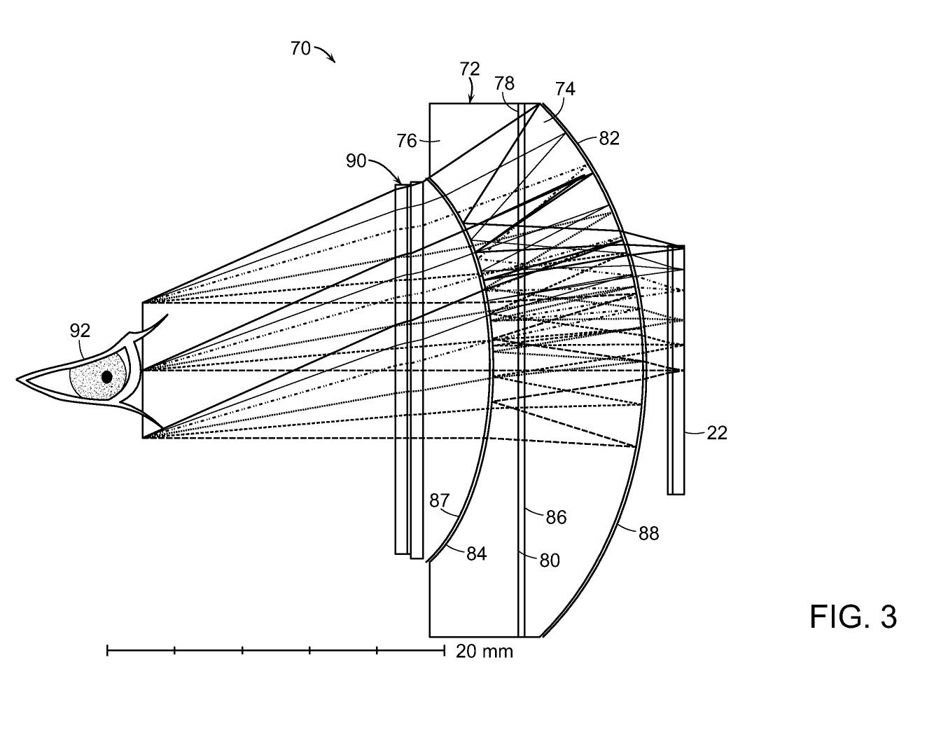

FIG. 3 is another embodiment of a reflective collimating eyepiece of the invention. As shown in FIG. 3, reflective collimating eyepiece 70 includes optical lens 72 that is a doublet. Doublet optical lens 72 includes first component 74 and second component 76. Each component defines a flat surface 78, 80 that abuts the other. This configuration has the advantage, for example, of allowing each of convex surface 82 of first component 74 and concave surface 84 of second component 76 to be fabricated as separate pieces, such as in the case where at least one of curved surfaces 82, 84 is aspheric.

In one embodiment, ¼ wave plate 86 is interposed between the flat surfaces 78, 80 between lens components 74, 76. ¼ waveplate 86 converts the circularly polarized light that passes/diffracts through beam splitter reflective coating 88 back into linearly polarized light that is reflected from curved linear polarizer 87 at concave surface 84. The linear polarized light reflected from curved linear polarizer 87 at concave surface 84 converts to circular polarized light at ¼ waveplate 86 and then is partially reflected at beam splitter reflective coating 88, where the reflected portion of the light is converted to opposite handedness The oppositely handed reflected light from beam splitter reflective coating 88 is then converted to linear polarized light at ¼ waveplate 86 and substantially, or essentially completely is transmitted across linear polarizer 87 at concave surface 84. This embodiment has the advantage, for example, of facilitating fabrication of reflective eyepiece, by allowing for use of a flat ¼ waveplate in construction. Beam splitter reflective coating 88 is at convex surface 82.

Absorptive linear polarizer 90 is located between eye 92 of a user of reflective collimating eyepiece 70 and curved reflecting surface 116 of eyepiece 70. The presence of absorptive linear polarizer 90 eliminates substantial reflection of light from eye 92 off of concave surface 84 that would be visible to the user, otherwise.

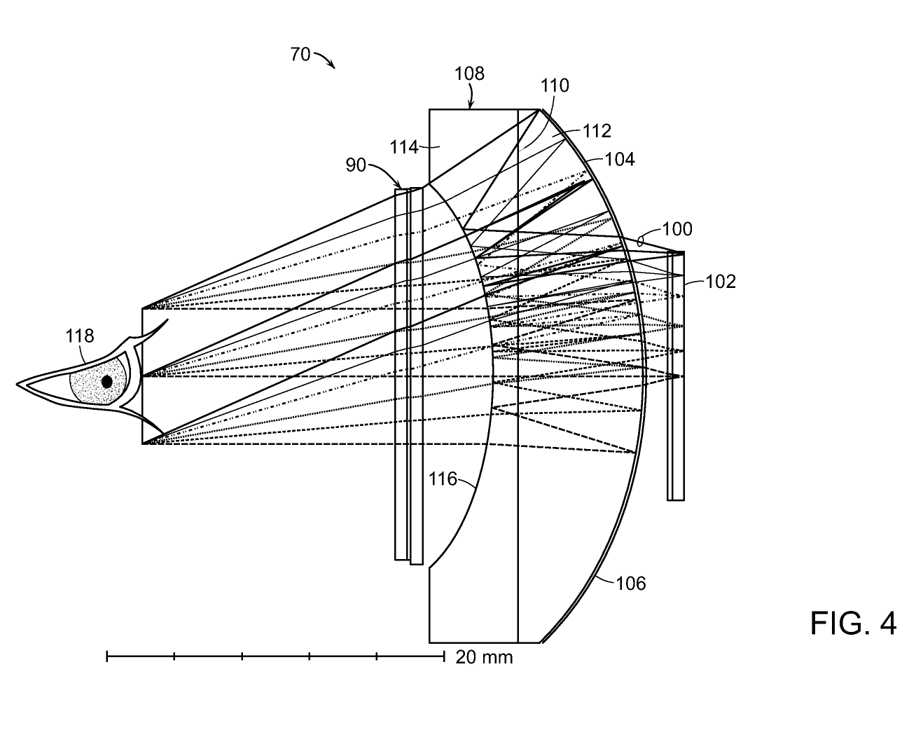

In another embodiment, the invention is a method for forming a magnified image that includes emitting circularly polarized light from display source 102, as schematically shown in FIG. 4. Circularly polarized light 100 from display source 102 is at least partially refracted across convex surface 104 of beam splitter reflective coating 106 and optical lens 108. Refracted circularly polarized light is then refracted by ¼ wave plate 110 between first lens component 112 and second component lens 114 of doublet optical lens 108 to form linearly polarized light. Refracted linearly polarized light is mostly, if not substantially all, reflected internally off of concave polarized reflector surface 116 of lens 108 to form reflected linearly polarized light. Reflected linearly polarized light passes through ¼ wave plate 110 to form circularly polarized light that is at least partially reflected internally off of beam splitter reflective coating 106 at convex surface 104, whereby a beam of opposite circular polarization of circularly polarized light is formed, which then crosses ¼ wave plate 110, thereby causing the beam of opposite circularly polarized light to be transformed to linearly polarized light that is transmitted across concave reflective surface 116 and then absorptive polarizer 90. The combination of the refraction and the reflection at the convex and concave surfaces, respectively, of the lens and of transmission across the ¼ waveplate (or film) collimates and magnifies the image of the display source. In one embodiment, absorptive linear polarizer 90 substantially eliminates reflection of light from eye of user off of concave surface 116 of the eyepiece that would otherwise be visible at eye 118.

Also it would also be possible to construct the eyepiece with the beam splitter coating on the concave surface and the polarizing reflector on the convex surface. This would require that an absorptive polarizer and a ¼ waveplate combination be located between the eye and the eyepiece to eliminate first pass transmission from the beamsplitter coating.

The relevant portions of all references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A reflective collimating eyepiece, comprising:
a) an optical lens, including
i) a concave surface, and
ii) a convex surface opposite the concave surface;
b) a beam splitter reflective coating at the convex surface; and
c) a circular polarizing reflector at the optical lens, whereby circularly polarized light from a circularly polarized light source is refracted at the beam splitter reflective coating and reflected at the circular polarizing reflector, and then reflected at the beam splitter reflective coating to form a beam of opposite circularly polarized light that is transmitted across the circular polarizing reflector, thereby collimating and magnifying the image of the circularly polarized light source.

2. The eyepiece of claim 1, wherein the optical lens is a singlet.

3. The eyepiece of claim 2, wherein the circular polarizing reflector includes a combination of a ¼ wave plate and a linear polarizing reflector.

4. The eyepiece of claim 3, further including an absorptive linear polarizer proximate to the concave surface, whereby light emitted from the optical lens at the concave surface is transmitted across the absorptive linear polarizer.

5. The eyepiece of claim 2, wherein the circular polarizing reflector includes a cholesteric liquid crystal film.

6. The eyepiece of claim 1, further including a display source opposite the reflective coating, wherein the display source directs predominantly circularly polarized light to the beam splitter reflective coating.

7. The eyepiece of claim 6, wherein the display source includes a non-polarized light source, and further including a polarizing filter between the non-polarized light source and the beam splitter reflective coating, and a ¼ wave plate between the polarizing filter and the beam splitter reflective coating, wherein non-polarized light emitted by the display source is polarized by the polarizer and ¼ wave plate, whereby the beam-splitter reflective coating receives circularly polarized light from the display source.

8. The eyepiece of claim 1, wherein the optical lens is a doublet that includes a first piece defining the convex surface, and a second piece defining the concave surface, the first and the second pieces together defining a planar interface between the convex and concave surfaces.

9. The eyepiece of claim 8, wherein at least one of the concave and the convex surfaces is aspheric.

10. The eyepiece of claim 9, wherein the circular polarizing reflector includes a ¼ wave plate at the interface between the first piece and the second piece, and a linearly polarizing reflector at the concave surface.

11. The eyepiece of claim 9, wherein at least one of the convex surface and the concave surface is aspheric.

12. The eyepiece of claim 1, further including an absorption polarizer at the concave surface that reduces reflection of light from an eye observing the image off the circular polarizing reflector surface of the eyepiece.

13. The eyepiece of claim 1, wherein the circularly polarizing reflector conforms to the concave surface.

14. The eyepiece of claim 13, wherein the circular polarizing reflector includes at least one member selected from the group consisting of a cholesteric liquid crystal film, a combination of a ¼ wave plate and a wire grid polarizer, and a combination of a ¼ wave plate film and a linear polarizing reflector.

15. A reflective collimating eyepiece, comprising:
a) an optical lens, including
i) a concave surface, and
ii) a convex surface opposite the concave surface;
b) a beam splitter reflective coating at the convex surface;
c) a circular polarizing reflector at the concave surface, whereby circularly polarized light from a circularly polarized light source is refracted at the beam splitter reflective coating and reflected at the circular polarized reflector, and then reflected at the beam splitter reflective coating to form a beam of opposite circularly polarized light that is transmitted across the circular polarized reflector, thereby collimating and magnifying the image of the display source; and
d) a display source opposite the beam splitter reflective coating, wherein the display source directs predominately circularly polarized light to the beam splitter reflective coating.

16. A reflective collimating eyepiece, comprising:
a) an optical lens, including
i) a first piece defining a convex surface,
ii) a second piece defining a concave surface, the first and second pieces together defining an interface between the converse and concave surfaces;
b) a ¼ wave plate at the interface between the first piece and the second piece;
c) a beam splitter coating at the convex surface; and
d) a circular polarizing reflector at the optical lens, whereby circularly polarized light from a circularly polarized light source is refracted at the beam splitter reflective coating and reflected at the circular polarizing reflector, and then reflected at the beam splitter reflective coating to form a beam of opposite circularly polarized light that is transmitted across the circular polarizing reflector, thereby collimating and magnifying the image of the circular polarized light source.

17. A method for forming a magnified image, comprising the steps of:
a) emitting circularly polarized light from a circularly polarized light source;
b) at least partially refracting the circularly polarized light across a convex surface of a beam splitter reflective coating and across an optical lens;
c) at least partially reflecting the refracted circularly polarized light internally off of a concave circular polarized reflector of the optical lens;
d) at least partially reflecting the reflected circularly polarized light internally off of the beam splitter reflective coating at the convex surface, whereby a beam of opposite circular polarization of the circularly polarized light is formed, thereby causing the beam of opposite circularly polarized light to be transmitted across the circular polarized reflector, thereby collimating and magnifying the image of the circularly polarized light source.
